(19) United States
(12) Patent Application Publication
(10) Pub. No.: US 2003/0084556 A1
(43) Pub. Date: May 8, 2003

(54) Pump plunger installation tool

(76) Inventor: Roy J. Dunlop, Nutterfort, WV (US)

Correspondence Address: DORITY & MANNING, P.A., POST OFFICE BOX 1449, GREENVILLE, SC, 29602-1449, US

(21) Appl. No.: 09/992,105

(22) Filed: Nov. 6, 2001

(51) Int. Cl. B23P 19/04

(52) U.S. Cl. 29/259

(57) ABSTRACT

A tool for inserting a plump plunger through a packing in a fluid end of a plunger pump enables easy and rapid insertion of the plunger through the packing without damaging the packing or the pump plunger.

### CROSS-REFERENCE TO RELATED APPLICATIONS

This is the first application filed for the present invention.

### MICROFICHE APPENDIX

Not applicable.

### TECHNICAL FIELD

The invention relates to pump maintenance and, in particular, to a tool for inserting a pump plunger through an aperture in a packing in a plunger pump.

### BACKGROUND OF THE INVENTION

Plunger pumps are used for pumping oil or other fluids, including slurries. Plunger pumps operate by rapidly reciprocating one or more plunger(s) in a pump chamber. As the plunger(s) reciprocates, check valves on opposite sides of the pump chamber co-operate to draw the fluid from a source. The pump plunger(s) is surrounded by a packing that provides a fluid seal at a top of the pump chamber. It is necessary from time to time to change the packing that provides the seal around the plunger(s). For example, the packing in heavily-used industrial pumps has to be changed at least once every two or three months. When the packing in a plunger pump is changed, the plunger is released from a drive mechanism and removed from the pump in a manner that is well known in the art. The old packing is removed, new packing is installed and the plunger is inserted through the new packing. Since the fit between the packing and the plunger must be fluid tight, inserting a plunger through new packing can be difficult, especially if the plunger is not perfectly aligned with an aperture in a center of the packing for receiving the plunger. Consequently, plunger installation is generally easier if two people cooperate to do the job. One person holds the plunger in alignment while the other person drives the plunger through the new packing using a hammer, or the like. Some plunger pumps have two to five plungers, so changing the packing is a time-consuming task. Furthermore, if the plunger is not well aligned with the aperture in the packing, insertion of the plunger can damage the packing and shorten its service life.

There is therefore a need for a tool that simplifies and facilitates the procedure for installation of a plunger in a plunger pump.

### SUMMARY OF THE INVENTION

The present invention provides a tool for inserting a pump plunger through an aperture in a packing in a fluid end of a plunger pump. The tool comprises a plunger guide attachable to the plunger pump, the plunger guide having an engagement end, an axial bore for centering the pump plunger with respect to the aperture and guiding the pump plunger as it is inserted, the engagement end having at least two connectors for removable attachment of a load plate; and, a threaded rod for engaging a threaded bore in the load plate, wherein rotation of the rod in a first direction when the load plate is attached to the connectors applies a drive force to an end of the pump plunger to insert the pump plunger through the aperture.

In accordance with a further aspect of the invention, the plunger guide includes an external thread for connecting the plunger guide to a plunger installation port in the plunger pump.

The threaded rod has a first end that contacts a top end of the plunger and a second end for transmitting a force to rotate the threaded rod.

In accordance with one embodiment of the invention, the load plate includes slots that receive the connectors to removably connect the load plate to the plunger guide. The connector has a first end connected to the plunger guide and a second, L-shaped end that engages the slots of the load plate.

In accordance with another embodiment of the invention, the load plate includes bores that receive the connectors to removably connect the load plate to the plunger guide. The connector may be a bolt or a T-bar that passes through the bores in the load plate and is connected to a plunger guide.

### BRIEF DESCRIPTION OF THE DRAWINGS

Further features and advantages of the present invention will become apparent from the following detailed description, taken in combination with the appended drawings, in which:

FIG. 1 is a schematic diagram of a fluid end of a plunger pump, with an attached tool in accordance with the invention for inserting a plunger through a packing in the plunger pump;

FIG. 2 is a schematic diagram illustrating a side elevational view of the plunger guide of the tool shown in FIG. 1;

FIG. 3 is a schematic diagram illustrating a top plan view of the plunger guide shown in FIG. 2;

FIG. 4 is a top plan view of a load plate shown in FIG. 1, the load plate including slots for receiving connectors associated with the plunger guide;

FIG. 5 is a top plan view of another embodiment of the load plate, which includes bores for receiving connectors that are connected to the plunger guide;

FIG. 6 is a top plan view of yet another embodiment of the load plate, which includes a bore in one end and a slot in the other end for receiving connectors that are connected to the plunger guide; and

FIG. 7 is a side elevational view of two different connectors for retaining the load plate shown in FIG. 5.

It will be noted that throughout the appended drawings, like features are identified by like reference numerals.

### DETAILED DESCRIPTION OF THE PREFERRED EMBODIMENT

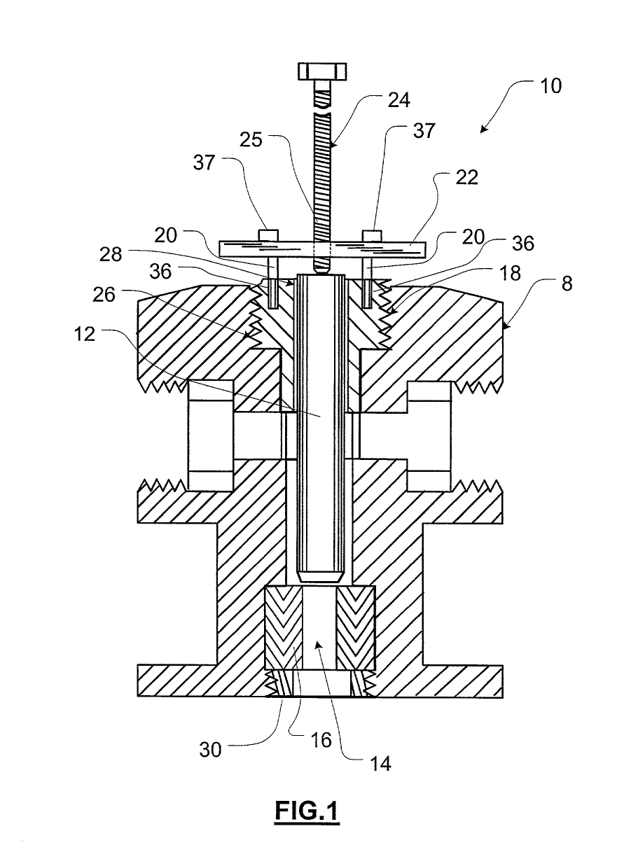

FIG. 1 is a schematic diagram of a fluid end 8 of a plunger pump with a tool 10 tool in accordance with the invention. The tool 10 is used to insert a pump plunger 12 through an aperture 14 in a packing 16 in the fluid end of the plunger pump 8. The tool 10 includes a plunger guide 18, connectors 20, a load plate 22, and a plunger insertion screw 24.

The operation of the tool 10 to insert the pump plunger 12 through the packing 16 is simple and easily and rapidly accomplished by one person. The plunger guide 18 is threaded into a plunger installation port 26 in the fluid end 8 of the plunger pump. The pump plunger 12 is inserted into an axial bore 28 in the plunger guide 18 until a driven end of the pump plunger 12 contacts the packing 16. The axial bore 28 has a diameter that is only slightly larger than a diameter of the pump plunger 12, so that the pump plunger is centered over the aperture 14 in the packing 16 and guided into the aperture 14 as it is inserted through the packing 16. The load plate 22 is connected to the plunger guide 18 by the connectors 20. Bottom ends of the connectors 20 threadedly engage threaded bores in the plunger guide 18 and the upper ends are connected to the load plate 22. When torque is applied to the plunger insertion screw 24, which is threaded through a threaded bore 25, plunger insertion screw 24 causes a drive force to be applied to the pump end of the pump plunger 12. When a torque of sufficient magnitude and duration is applied to plunger insertion screw 24, the pump plunger 12 is inserted through the aperture 14 in the packing 16. Since the pump plunger 12 is accurately aligned with the aperture 14 in the packing 16, the pump plunger is easily inserted without damaging the packing 16.

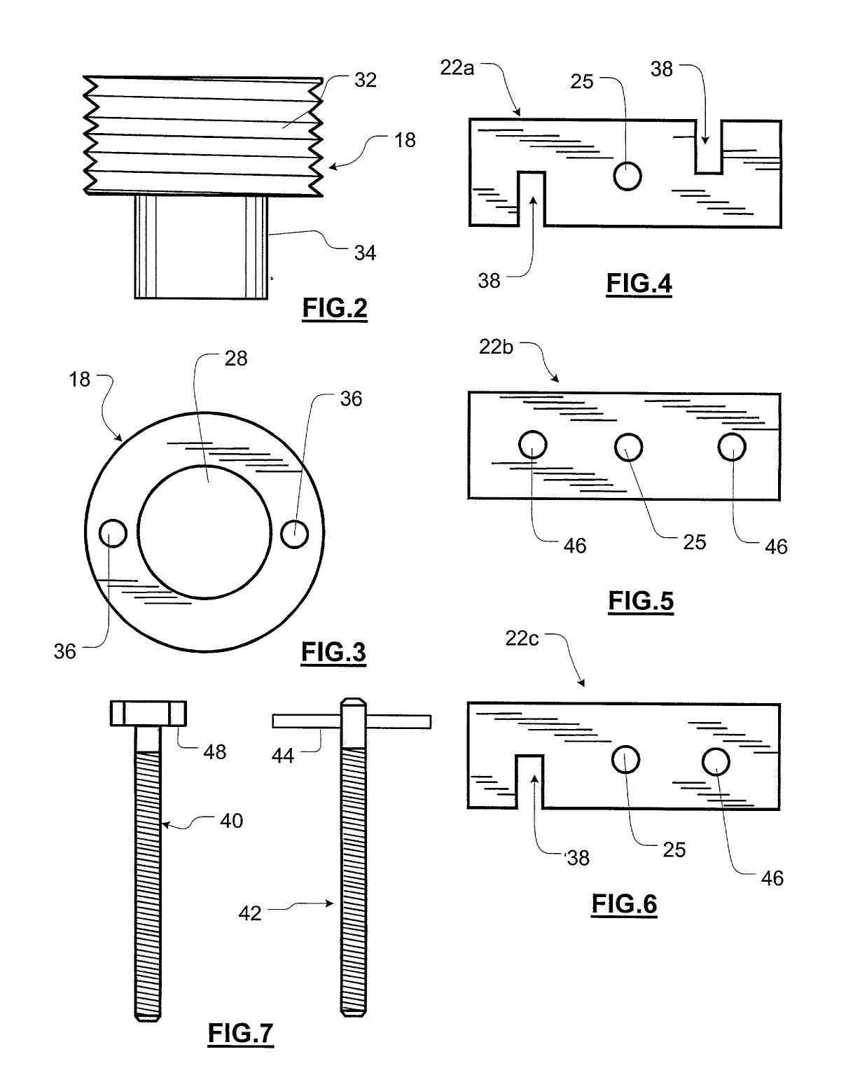

FIG. 2 is a side view of the plunger guide 18 which includes a threaded top end 32 that is screwed into the pump plunger installation port 26 (FIG. 1), and a bottom end 34 that extends the axial bore 28 to ensure that the pump plunger 12 is accurately guided as it is inserted through the packing 16.

FIG. 3 is a top plan view of the plunger guide 18, which includes the axial 28 for guiding the pump plunger 12 and two threaded bore 36 for receiving the connectors 20.

FIG. 4 is a top plan view of one embodiment of the load plate 22 shown in FIG. 1. In this embodiment, the load plate 22 includes slots 38 in opposite side edges. The slots 38 receive top ends of the connectors 20 shown in FIG. 1. The top ends 37 of the connectors 20 are L-shaped. The shape of the slots is designed to receive the L-shaped ends 37 of the connectors to removably attach the load plate 22 to the plunger guide 18.

Another embodiment of the load plate 22 is shown in FIG. 5. The load plate 22b is attached to the plunger guide using bolts 40 or the like. The bolts are inserted through bores 46 in the load plate 22b and screwed into the threaded bores 36 (FIG. 3) in the top end of the plunger guide 18. The L-shaped connectors 20 shown in FIG. 1 can also be used with the load plate 22b.

FIG. 6 is a top plan view of yet another embodiment of the load plate 22 shown in FIG. 1. The load plate 22c shown in FIG. 6 includes a bore 46 in one end, and a slot 38 in the opposite end. The bore 46 receives, for example, an L-shaped connector 20 (FIG. 1) or a bolt 40 (FIG. 5). The slot 38 receives, for example, the L-shaped connector 20. The load plate 22c permits a pump plunger 12 (FIG. 1) to be inserted into the axial bore 28 of the plunger guide 18 without removing the load plate 22c. To accomplish this, the load plate 22c is rotated about the connector inserted through the bore 46 to expose to axial bore 28 in the plunger guide 18, as will be understood by those skilled in the art. After a pump plunger 12 is inserted, the load plate is rotated back so that the other connector engages the slot 38, and the pump plunger 12 is inserted through the aperture 14 in the packing 16, as described above. This embodiment of the load plate 22c permits the tool 10 to remain in an assembled condition at all times, so that parts are less likely to be disassociated and lost.

FIG. 7 illustrates an alternate embodiment of the plunger insertion screw 24. A threaded screw 42, adapted to threadedly engage the bore 25 of the load plate 22, includes a handle 44 received in a radial bore through the threaded screw 42. The handle 44 provides leverage to permit the threaded screw 42 to be turned to insert the pump plunger 12 through the aperture 14.

The tool in accordance with the invention greatly facilitates the insertion of pump plungers through new packings in plunger pumps. The job is easily performed by a single person in a very short period of time. Since the pump plunger is accurately aligned with the aperture in the packing, regardless of an orientation of the pump, the pump plunger is consistently inserted without damage to the packing. Furthermore, since the pump plunger is only subjected to a constant axial force, it is never damaged as can happen if it is driven through the packing using a hammer and punch.

The embodiments of the invention described above are intended to be exemplary only. The scope of the invention is therefore intended to be limited solely by the scope of the appended claims.

I/we claim:

1. A tool for inserting a pump plunger through an aperture in a packing in a plunger pump, comprising:
a plunger guide attachable to the plunger pump, the plunger guide having an engagement end, an axial bore for receiving and centering the pump plunger with respect to the aperture and guiding the pump plunger as it is inserted, the engagement end including at least two connectors for removable attachment of a load plate; and
a plunger insertion screw for engaging a threaded bore in the load plate, wherein when the load plate is attached to the connectors rotation of the plunger insertion screw in a first direction applies a drive force to an end of the pump plunger to insert the pump plunger through the aperture in the packing.

2. The tool as claimed in claim 1, wherein the plunger guide comprises an external thread for connecting the plunger guide to a plunger installation port in a fluid end of the plunger pump.

3. The tool as claimed in claim 1, wherein the plunger insertion screw has a first end that contacts a top end of the pump plunger and a second end for transmitting a force to rotate the threaded rod.

4. The tool as claimed in claim 1, wherein the load plate includes slots that receive the connectors to removably connect the load plate to the plunger guide.

5. The tool as claimed in claim 4, wherein the connector has a first end mounted to the plunger guide and second L-shaped end that engages a top of the load plate when the connector is received in a slot in the load plate.

6. The tool as claimed in claim 1, wherein the load plate includes bores that receive the connectors to removably connect the load plate to the plunger guide.

7. The tool as claimed in claim 6, wherein the connector is a bolt that passes through the load plate and is connected to the plunger guide.

8. The tool as claimed in claim 1, wherein the load plate includes a bore in one end that receives a connector to connect the load plate to the plunger guide, and a slot in an opposite end that receives a second connector to permit the load plate to be rotated away from the axial bore in the plunger guide to permit a pump plunger to be inserted into the axial bore.
